(19) United States
(12) Patent Application Publication
(10) Pub. No.: US 2010/0299170 A1
(43) Pub. Date: Nov. 25, 2010

(54) Stages, Phases in a Project Workflow

(75) Inventors: Alexandru Savescu, Issaquah, WA (US); Samuel Chung, Kirkland, WA (US); Pradeep GanapathyRaj, Bellevue, WA (US); Biatrlce Ambrosa, Redmond, WA (US); Collin Tibbetts, Seattle, WA (US); John Lee Thoni, Seattle, WA (US); Luke Humphrey, Issaquah, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/468,616

(22) Filed: May 19, 2009

(51) Int. Cl. G06Q 10/00

(52) U.S. Cl. 705/8

(57) ABSTRACT

A method is presented for creating a life cycle workflow for a project on a server computer. One or more workflow phases are created on the server computer. Each workflow phase corresponds to a plurality of workflow stages for the project. One or more workflow stages are created on the server computer. Each workflow stage corresponds to a specific sequence of workflow activities. One or more project detail pages are created on the server computer. Each project detail page is a web page that is made visible during the workflow stage. When a workflow stage is created, a workflow phase is selected to be associated with the workflow stage and one or more project detail pages are selected for the workflow stage.

### BACKGROUND

Projects, proposals and business cases often go through a multi-stage decision making process known as a governance process. During a governance process, various checks are made at each stage. For example, a project typically needs to be approved in an approval stage before a project is designed in a design stage.

Because projects, proposals and business cases are often complex, it can sometimes be difficult to distinguish the stages of a project and determine the decisions that need to be made at the various stages of a project. It can also sometimes be difficult to model and report on the governance process for a project, proposal or business case.

### SUMMARY

Embodiments of the disclosure are directed to creating a life cycle workflow for a project on a server computer. One or more workflow phases are created on the server computer. Each workflow phase corresponds to a plurality of workflow stages for the project. One or more workflow stages are created on the server computer. Each of the one or more workflow stages corresponds to a specific sequence of workflow activities. Each workflow stage has an identifier. One or more project detail pages are created on the server computer. Each project detail page is a web page made visible during a workflow stage.

When a workflow stage is created, a workflow phase is selected to be associated with the workflow stage. The workflow phase is selected from the one or more workflow phases made available on the server computer. When a workflow stage is created, one or more project detail pages are selected for the workflow stage.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that provides a capability to create, store and access phases and stages in a project workflow.

FIG. 2 shows example modules of an example project server of FIG. 1 that implements a capability for phases and stages in a project workflow.

FIG. 3 shows example modules of an example project database of FIG. 1 that stores definitions of phases and stages used in a project workflow.

FIG. 4 shows an example flowchart of a method for creating a life cycle workflow for a project.

FIG. 5 shows an example flowchart of a method for using a life cycle workflow for a project.

FIG. 6 shows example components of the project server computer of FIG. 2.

### DETAILED DESCRIPTION

The present application is directed to systems and methods for organizing a project into phases and stages corresponding to workflow activity during the project life cycle. The phases are further organized by enterprise project type. Various properties are defined for the project stages to reflect workflow activity during the stage. Project detail pages are created for each stage to permit a user to select workflow properties for the stage. The project detail pages are rendered on a server computer from a plurality of web parts. The web parts can have one or more custom fields.

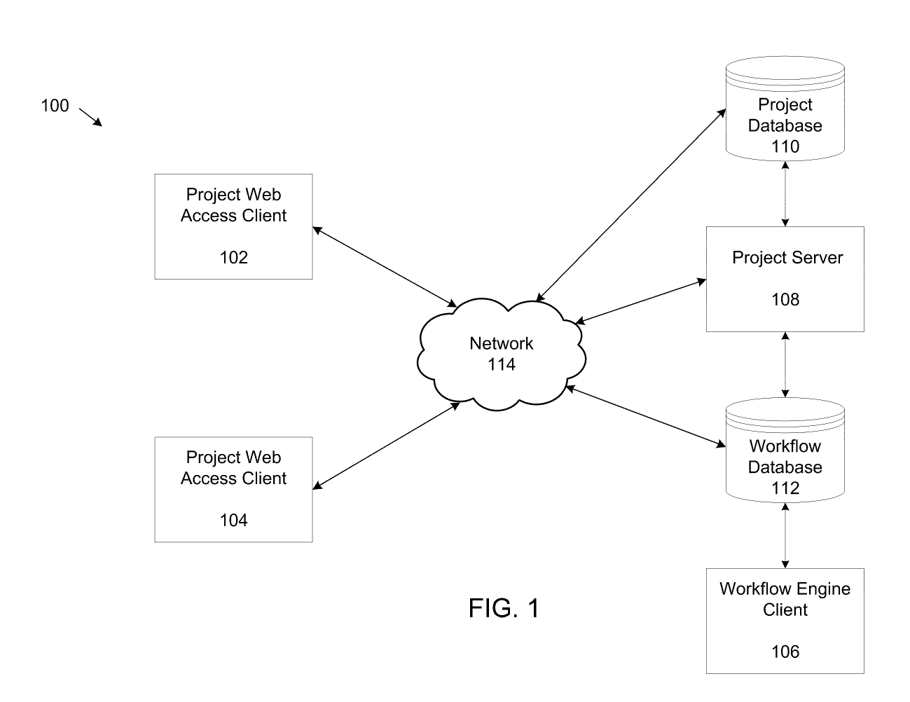

FIG. 1 shows an example system 100 that supports phases and stages in project workflow. The system 100 includes clients 102, 104, 106, a server 108, a project database 110, a workflow database 112 and a network 114. More or fewer clients, servers and databases can be used. In this disclosure, the terms client and client computer are used interchangeably, and the terms server and server computer are used interchangeably.

Among the plurality of information stored on the clients 102, 104, 106 is a client operating system (“OS”) and client applications. The client OS is a program that manages the hardware and software resources of the client system. The client applications utilize the resources of the clients 102, 104, 106 to directly perform tasks specified by the user. For example, the clients 102, 104, 106 include one or more software applications. Clients 102, 104 include a software application that permits a user on clients 102, 104 to access and update project management system information over the Internet. An example of such a software application is Microsoft Office Project Web Access from Microsoft Corporation of Redmond, Wash. Client 106 includes a software application that permits a user on client 106 to create a sequential workflow that includes a sequence of workflow activities. The software application also permits the user to set a portion of the workflow as a workflow stage. An example of such a software application is Microsoft Visual Studio 2008 from Microsoft Corporation of Redmond, Wash. In example embodiments, a SetProjectStage activity on the software application delimits the workflow into a workflow stage.

Server 108 is a server that implements project management system software, such as Microsoft Project from Microsoft Corporation of Redmond, Wash. In example embodiments, server 108 can be located within an organization or can be part of a system of shared services. An example system of shared services is a SHAREPOINT® team services portal server service provided by Microsoft Corporation.

Project database 110 provides a data store for example project server 108. Project database 110 includes project data for one or more projects hosted on project server 108. Examples of project data include information describing, tasks, resources, task assignments, project schedule, project costs etc. Other examples of project data are possible. Project database 110 also stores definitions of phases and stages. FIG. 1 shows project database 110 external to project server 108. However, in example embodiments, project database 110 can be included within project server 108.

Workflow database 112 stores workflow activity data. A workflow is a pattern of activities that accomplishes a specific purpose. For example, a workflow for defining a project may include activities such as determining a name for the project, describing the purpose of the project, defining the scope of the project, etc. Workflows may include sequential operations or may include branches dependent on the state of an operation. Project server 108 uses the phases and stages definitions to organize a project. Workflow activity data is typically made available to users of SHAREPOINT® and is stored separately from project data on workflow database 112. In example embodiments, workflow database 112 is a SHAREPOINT® database.

A software application such as Microsoft Visual Studio 2008 can be used to create workflows by creating workflow activities and connecting the workflow activities, either sequentially or via branches. A workflow consists of a plurality of workflow activities. In addition, portions of a workflow can be assigned a name and saved on example workflow database 112 as a workflow stage. A workflow can include a plurality of workflow stages. In example embodiments, a SetProject Stage activity in the software application is used to set workflow stages. Workflow database 112 stores one or more workflow stages corresponding to specific workflows.

Workflows on Microsoft Visual Studio 2008 are typically built using Windows Workflow Foundation technology. Windows Workflow Foundation is a technology provided by Microsoft Corporation of Redmond, Wash. for defining, executing and managing workflows. Windows Workflow Foundation technology is part of the .Net Framework from Microsoft Corporation.

When a project is created in a business organization, a governance process is often used to ensure that the project is aligned with organizational goals and budgetary considerations. In the governance process a project is typically organized into phases and stages. Stages are subject to review and one stage may need to be approved before the project can proceed to the next sequential stage. For example, an initial project proposal may need to be reviewed and approved before a more detailed project proposal is authorized.

The governance process is typically managed by an administrator for the project. The administrator, for example an administrator on client 102, can access project server 108 via network 114 and create a life cycle for the project. Example client 102 runs a project web access software application, for example Microsoft Office Project Web Access, that permits the administrator on client 102 to remotely access project server 108.

When the administrator on client 102 creates a life cycle for the project, the administrator typically organizes the project into phases and stages. A stage corresponds to a specific sequence of workflow activities. A phase is a grouping of stages. For example, stages may be created for project proposal details, for a project review, etc. Other stages are possible. Example phases may be to create a project, select a project for review and approval, plan a project and manage a project. Other phases are possible.

The administrator also customizes one or more web pages for each stage. The web pages, also known as project detail pages, permit a user to enter data for a stage. A project detail page is built from web parts and includes one or more customizable fields and other web parts. For example, a stage for creating a project idea could include fields for entering a project name, describing the project, entering a proposed cost for a project, etc. Each field is customizable to define properties for the field. For example, a field for project cost may be made read only to ensure that the project cost cannot be changed once the cost is entered and approved. Making a custom field read only so that data cannot be modified after the data is entered is known as locking down the field.

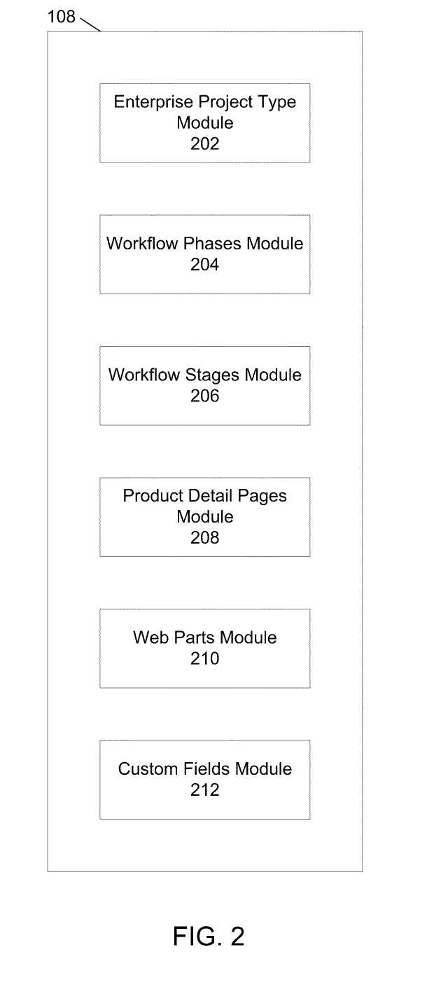

FIG. 2 shows example detailed modules of project server 108. Project server 108 includes an enterprise project type module 202, a workflow phases module 204, a workflow stages module 206, a product detail pages module 208, a web parts module 210 and a custom fields module 212.

The example enterprise project type module 202 permits project life cycle data to be organized, saved and selected according to an enterprise project type. An enterprise project type is an identifier that classifies a workflow life cycle according to a specific business purpose. For example, an administrator may organize a project life cycle into phases and stages for a plurality of business enterprises. Each project life cycle may be different, including different phases and stages and the stages may include different project detail pages for entering project information. However, one or more projects for a specific business may use the same project life cycle. The example enterprise project type module permits a unique enterprise project type to be associated with a project life cycle used by a specific business. When a project manager creates a new proposal for the business, the project manager can select the enterprise project type corresponding to the business and be assured that the proper phases, stages, and web pages for the project are used.

The example enterprise project type module 202 can also associate enterprise project types with departments, with task/schedule templates and with workspace templates. When an enterprise project type is associated with one or more departments, the enterprise project type is filtered based on the department of the user. When an enterprise project type is associated with task/schedule templates, a list of tasks and associated schedules for those tasks that are used with the enterprise project type are displayed. This avoids the need for a user, for example a project administrator on client 104 using Microsoft Web Access, to reenter the tasks associated with an enterprise project type.

When an enterprise project type is associated with workspace templates, an enterprise project type can be associated with a collaboration website for a project via SHAREPOINT®. This permits a user to enter issues associated with a project on the website and tie the issues back to a project task. The association of enterprise project types with departments, with task/schedule templates and with workspace templates is made via the project server 108 user interface associated with a remote project web access program such as Microsoft Office Project Web Access.

The example workflow phases module 204 process the phases of a project life cycle permitting workflow phases to be created by an administrator and selected by a user. A project life cycle is organized into one or more phases. Some example workflow phases of a project cycle are create, select, plan and manage. In an example create phase, an idea is proposed for a project and initial project details are proposed. In an example selection stage, the project is selected, reviewed and approved. In an example planning phase, tasks and resources are identified for the project and a project schedule is created. In an example manage phase the project is monitored to determine whether the project schedule dates are being met. Other example phases are possible.

The example workflow stages module 206 processes the creation, administration and selection of workflow stages for a project life cycle. A workflow stage corresponds to a specific sequence of workflow activities. Some examples of workflow stages include initial proposal details, initial review, proposal details, selection review, final assessment, etc. For example, initial proposal details could include workflow activities including waiting for a required custom field to be filled in by a user, evaluating the custom field value and determining the next workflow activity based on the evaluation. For example, based on the value of a custom field, control could be redirected to a next sequential workflow stage.

The example workflow stages module 206 creates workflow stages for the project and assigns an identifier to each workflow stage. Each workflow stage is given a name and a description that lets the user understand the purpose of the workflow stage.

The workflow for the project is typically created on a system external to project server 108, for example on workflow engine client 106, via a software application such as Microsoft Visual Studio. A specific sequence of workflow activities in the workflow is designated as a workflow stage by a marker activity, for example SetProjectStage in Microsoft Visual Studio. The workflow stage identifier created in the example workflow stages module 206 is set as a property of the specific sequence of workflow activities designated by the marker activity. This correlates the workflow stage created in workflow stages module 206 with the specific sequence of workflow activities identified as a workflow stage in Microsoft Visual Studio.

Workflow stage information, for example the name and description of the workflow stage, the project detail pages associated with the workflow stage, etc. are typically stored on a database external to project server 108, for example on project database 110. Workflow activity data is stored on example workflow database 112. Project server 108 and workflow database 112 are typically connected to a shared services system such as SHAREPOINT®. The example workflow stages module 206 obtains one or more workflow stages from example workflow database 112 and makes the workflow stages available for selection on project server 108.

The workflow for a project comprises of a plurality of workflow stages. The marker activity, for example SetProjectStage in Microsoft Visual Studio, is what sets a specific sequence of workflow activities to a workflow stage. In addition, the sequence of workflow activities designated as a workflow stage in Microsoft Visual Studio can be reused and applied to more than one workflow stage, for example in different projects, by associating the identifier for the workflow stage, as assigned in workflow stages module 206, to the workflow stage identified by the SetProjectStage marker activity in Microsoft Visual Studio.

The example project detail pages module 208 provides one or more web pages for entering workflow stage data and for displaying status for a workflow stage. A web page created by the example project detail pages module 208 is known as a project detail page. A project administrator, for example an administrator on example project web access client 102 can create a project detail page from one or more web parts. Typically, the project administrator designates one the of the project detail pages as a workflow status page. The workflow status page is displayed when the workflow stage is activated and provides status information for the workflow stage. The workflow status page also typically provides information for one or more project detail pages associated with the workflow stage and permits the one or more project detail pages to be selected by a user.

The example web parts module 210 provides a plurality of web parts from which the example project detail pages module 208 renders a project detail page. Web parts are elements of a web page and can include banners, headers, tables, list boxes, edit boxes, control buttons, scroll bars, etc. The example web parts module 210 permits an administrator to select one or more web parts when building a project detail page.

The example custom fields module 212 provides one or more custom fields that are typically associated with a stage, phase and project detail page. Example custom fields may include proposal cost, approved start date, areas impacted, assumptions, business need, etc. Other custom fields are possible. A project administrator can add one or more custom fields to a project detail page.

The example custom fields module 212 also permits a project administrator to designate a “required” property for a custom field. Designating a custom field as required makes it mandatory that a user enter data into the custom field. When a custom field on a project detail page is designated as required, the custom field must be filled out before the project detail page can be saved. When a custom field is designated as required, the custom field is typically highlighted to indicate that the custom field is a required field. For example, the custom field may be shown with an asterisk next to it or the label for the custom field may be shown in red. Other means of highlighting the custom field are possible. When a project manager attempts to submit a project in order to get to the next workflow stage, if any custom fields designated as required are not filled out, the next workflow stage is not activated. In example embodiments, a dialog box is displayed listing the names of all required fields for the workflow stage that do not have a value entered.

The example custom fields module 212 also permits a project administrator to designate a “read only” property for a custom field for a workflow stage. A custom field designated as read only specifies that the field cannot be modified while the project is in the workflow stage. The field is editable in a previous stage but becomes read only as the project advances in the workflow. For example, after a proposal cost is entered into a project detail page and the proposal cost is approved, a user can no longer change the project cost. Designating a custom field as read only is also known as locking down the custom field.

The example workflow stages module 206 also permits a user, for example a project administrator, to designate a strategic impact behavior for a workflow stage. A strategic impact behavior specifies how a stage correlates business drivers for the organization. For example, one business driver could be to improve customer satisfaction. Another business driver could be to reduce expenses, etc. For each business driver, the user can designate a business impact, for example a low impact, a moderate impact or a high impact. The user can also designate a read only, required or read/write property for the strategic impact behavior that is maintained during the workflow stage.

The example workflow stages module 206 also permits a user to select whether a project needs to be checked in when the project is submitted to go to the next workflow stage. Sometimes workflow stages include workflow activities that require that updates be made to project properties. For example, workflow activities in a workflow stage may include an UpdateProject Property activity to set a custom field value for the project. In order for the workflow to update the custom field value, the project needs to be checked out and the project cannot be checked out unless the project is in a checked in state. Checking out a project permits modifications to be made to a workflow stage and only one user can check out a project at one time. If a workflow stage is not designated as requiring check in, any workflow activities that require making modifications to the workflow stage are blocked until such time that the project is checked in. For these reasons, the example workflow stages module 206 includes a check in field, corresponding to a project check in checkbox that indicates the project must be checked in when the project is submitted to go to the next workflow stage. The project check in checkbox is located on a user interface provided by Microsoft Office Project Web Access.

The example custom fields module 212 also permits a user to control the behavior of a custom field and to select whether a custom field is controlled by workflow. For example, custom field may be specified to have a read only behavior and a required behavior. By selecting that the behavior of the custom field is controlled by workflow, the behavior of the custom field can be made read only or required at the workflow stage level. When the custom field is edited using Microsoft Office Project Web Access, the example workflow stages module 206 determines whether the custom field has read only or required behavior for the current workflow stage. When a custom field is selected to have a specific behavior and the behavior of the custom field is controlled by workflow, the example workflow stages module 206 enables the behavior of the custom field when the workflow stage is activated. The selection of whether the behavior of a custom field is controlled by workflow is made via the user interface provided by Microsoft Office Project Web Access.

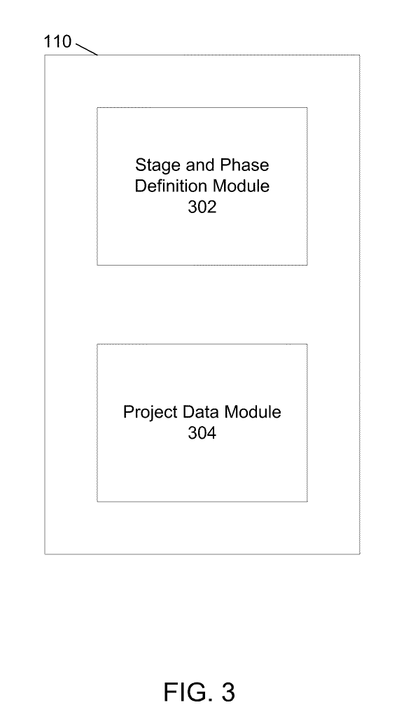

FIG. 3 shows example detailed modules for example project database 110. The example project database 110 includes an example stage and phase definitions module 302 and an example project data module 304. The example stage and phase definitions module 302 stores a workflow stage definition for one or more sequences of workflow activities stored on example workflow database 112. Each workflow stage definition stored in the example stage and phase definitions module corresponds to an available workflow stage on project server 108. The example stage and phases definitions module 302 also stores workflow phase definitions. Each workflow phase has one or more workflow stages associated with the workflow phase. The example project data module 304 stores project data including tasks, resources, schedules, etc.

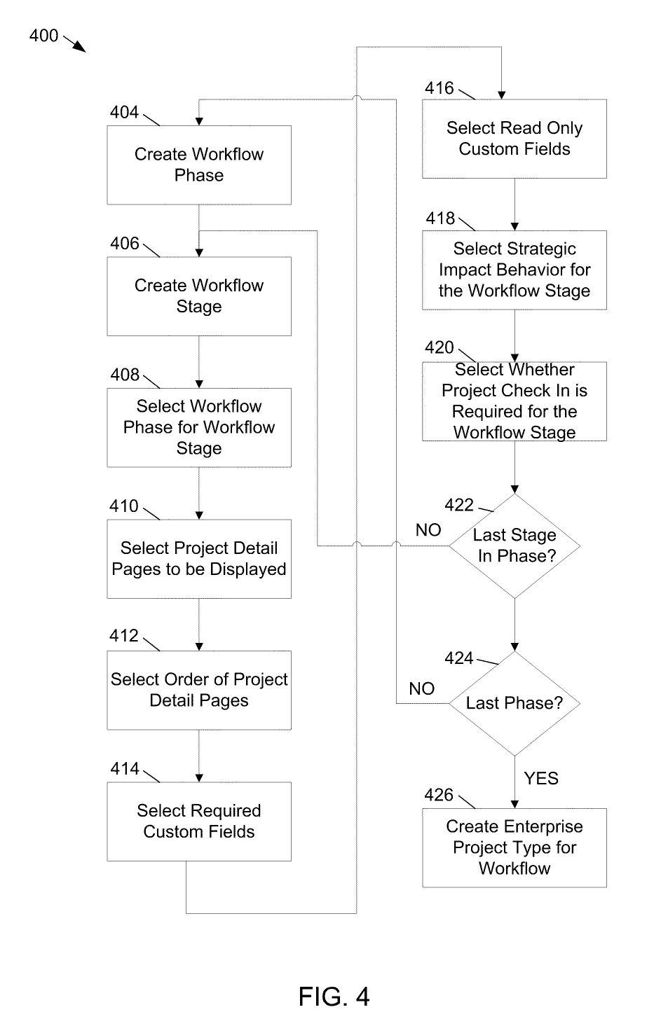

FIG. 4 shows an example flowchart of a method 400 for creating a life cycle workflow for a project. The project life cycle is typically created by a project administrator who logs on to project server 108. The project administrator, for example a user on project web access client 102, typically logs on to project server 108 via a remote access program such as Microsoft Office Project Web Access.

At operation 404, the project administrator creates a workflow phase for the project. A workflow phase describes the organization of a project in terms of project phases. Some example workflow phases that are typically used in a project are create, select, plan and manage. A workflow phase includes one or more workflow stages.

At operation 406, the project administrator creates a workflow stage for the project. The workflow stage is given a name and a description that lets a user understand the purpose of the workflow stage. The workflow stage is also given an identifier that is used by a software application such as Microsoft Visual Studio to associate the workflow stage with a specific sequence of workflow activities. The specific sequence of workflow activities is typically created via a software application such as Microsoft Visual Studio and designated as a workflow stage in the workflow by a marker activity, for example SetProjectStage. The workflow stage identifier is set as a property of the specific sequence of workflow activities designated by the marker activity. This correlates the workflow stage as created in operation 406 with the specific sequence of workflow activities. Example workflow stages include initial proposal details, initial review, detailed proposal details, selection review, etc.

At operation 408, the project administrator selects a workflow phase to be associated with the workflow stage. Every workflow stage is associated with a workflow phase. The workflow phase selected is typically the workflow phase created in operation 404. However, any available workflow phase on project server 108 can be associated with a workflow stage.

At operation 410, the project administrator selects one or more project detail pages for the workflow stage created in operation 406. The project detail pages are selected from available project detail pages on project server 108. Each project detail page is created from web parts made available via web parts module 210. The web parts include web page elements such as banners, logos, headers, tables, list boxes and fields that capture various project information, for example schedule or strategic impact information, etc. In addition, web parts module 210 includes at least one web part that has custom fields.

At operation 412, the project administrator selects the order of the project detail pages selected at operation 410. The project detail pages are typically listed on the project remote access program user interface and the order is selected by moving the project detail pages up or down on the user interface. The first project detail page displayed to a user is a workflow status page that is displayed when a workflow stage is activated. The workflow status page lists the project detail pages selected in operation 410 in the order selected in operation 412.

At operation 414, the project administrator selects required custom fields for the workflow stage. The project administrator makes the selection from a list of workflow controlled custom fields that are available on project server 108, as specified by custom fields module 212. All required custom fields must be entered for a workflow stage before the project workflow can advance to the next workflow stage. The required custom fields need to be included in the project detail pages for the workflow stage to ensure that the custom field is entered during the workflow stage.

At operation 416, the project administrator selects read only custom fields for the workflow stage. The project administrator makes the selection from a list of workflow controlled custom fields that are available on project server 108. A read only custom field locks the field and prevents a user from modifying the field during the workflow stage.

At operation 416, the project administrator selects a strategic impact behavior for the workflow stage. A strategic impact behavior specifies how a stage correlates business drivers for the organization. Example business drivers include improving customer satisfaction and reducing business expenses. For each business driver selected, the project administrator selects a business impact of the business driver. The project administrator can select a low impact behavior, a moderate impact behavior and a high impact behavior. The strategic impact behavior can either be required, read only or read/write.

At operation 420, the project administrator determines whether the project must be checked in for the workflow stage to operate properly. The project must be checked in if workflow activity within a workflow stage includes making modifications to the project.

At operation 422, the project administrator makes a determination whether any additional workflow stages need to be created for the workflow phase. When it is determined that additional workflow stages need to be created for the workflow phase, control passes to operation 406 to create a new workflow stage. When it is determined that no additional workflow stages need to be added for the workflow phase, at operation 424 the project administrator makes a determination whether any additional workflow phases need to be created for the project. When it is determined that additional workflow phases need to be added for the project, control passes to operation 404 to create a new workflow phase.

When it is determined that no additional workflow phases need to be added for the project, at operation 426, an enterprise project type is created for the life cycle workflow of the project that associates the workflow stages defined for the life cycle workflow with the enterprise project type. The enterprise project type is a type field associated with a specific type of proposal. For example, a project proposal for a particular business may predefine phases and stages that are needed for the project proposal. In addition, project detail pages may be designed that are specific to the business, for example that includes a logo or banner for the business. When an enterprise project type is selected, the predefined phases, stages and project detail pages for the project type are made available for selection when the life cycle workflow for the project is created.

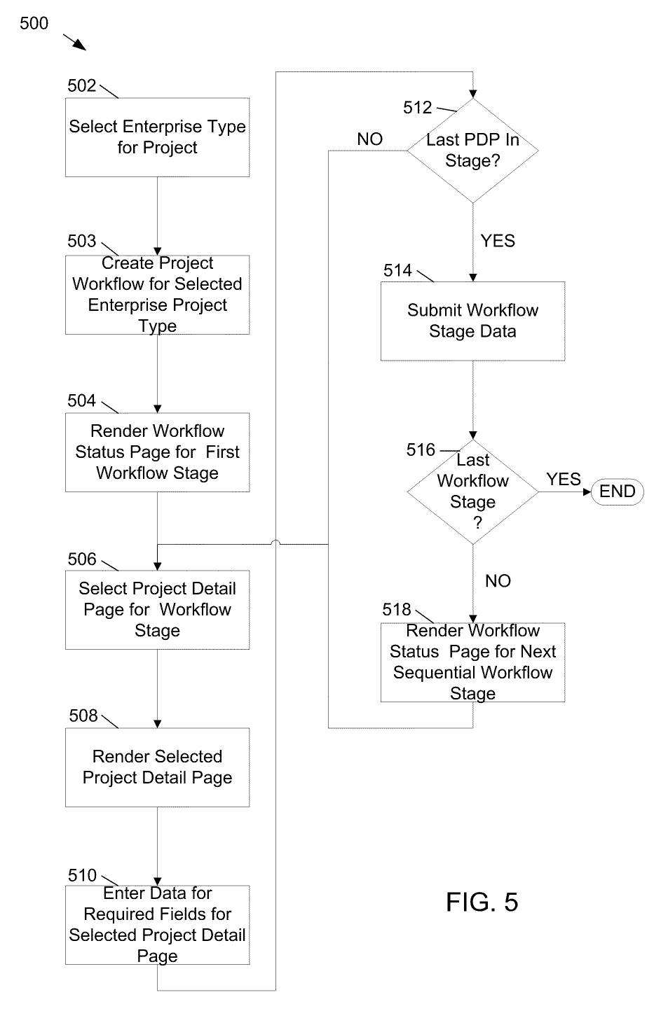

FIG. 5 shows an example flowchart of a method 500 for using a life cycle workflow for a project. For this example method, a project life cycle has already been created for a project and a user, for example a project manager on project web access client 104, enters project data for the project using a remote project web access interface such as Microsoft Office Project Web Access.

At operation 502, an enterprise project type is selected for the project. The enterprise project type is selected from a plurality of enterprise project types stored on project server 108. The project manager typically selects an enterprise project type corresponding to a specific type of project for a specific business organization. For example, a project proposal for business XYZ includes workflow phases, workflow stages and project detail pages that are needed for the specific project proposal. At operation 503, an instance of a project workflow is created for the selected enterprise project type. When a project is created using an enterprise project type, a new workflow instance is created and the workflow phases, stages and project detail pages defined for the enterprise project type are made available, based on a workflow/enterprise project type association.

At operation 504, the workflow status page for the first workflow stage in the project is rendered and displayed to the user. Typically, the workflow status page displays general information about the project or the workflow stage, such a description of the current project state, a list of all stages and phases, the status of completed stages, etc. The workflow status page also lists the available project detail pages for the workflow stage.

At operation 506, the user on client 104 selects a project detail page from the list of available project detail pages displayed on the workflow status page. At operation 508, the selected project detail page is rendered for the user.

At operation 510, the user on client 104 enters data into one or more fields on the selected project detail page. One or more fields are typically designated as required fields. Requested data must be entered into all the required fields on the selected project detail page before the next project detail page for the project can be displayed. An example of a required field is a proposal cost field.

At operation 512, the user on client 104 determines whether the rendered project detail page is the last project detail page for the first workflow stage. When the user determines that the rendered project detail page is not the last project detail page for the first workflow stage, control passes to operation 506 and the user selects another project detail page from the list of available project detail pages displayed on the workflow status page. When the user determines that the rendered project detail page is not the last project detail page for the first workflow stage, at operation 514, the user submits the first workflow stage data for the project. Submitting workflow stage data typically consists of clicking on a submit button on the remote Project Office Web Access interface.

After workflow stage data is submitted, at operation 516 the user determines whether the workflow stage for which workflow stage data is submitted is the last workflow stage in the project. When it is determined that the workflow stage for which workflow stage data is submitted is not the last workflow stage in the project, at operation 518, a workflow status page is rendered for the next sequential workflow stage. The workflow status page lists status for the workflow stage and that also lists the project detail pages associated with the workflow stage. Control then passes to operation 506 and the user selects a project detail page from the list of available project detail pages displayed on the workflow status page.

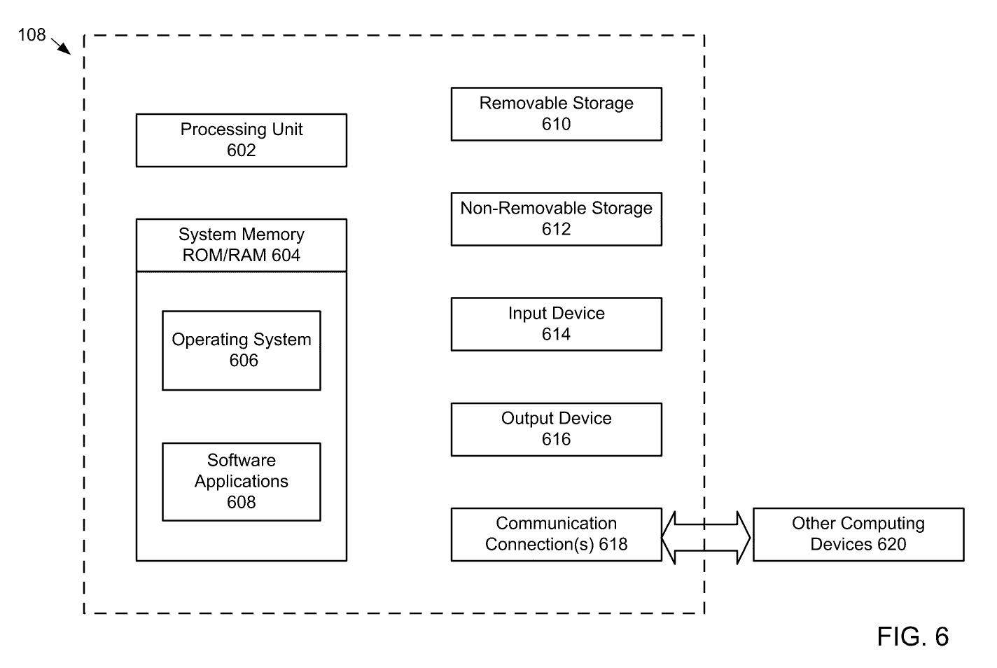

With reference to FIG. 6, example components of server 108 are shown. Clients 102, 104, 106 are configured in a similar manner.

In example embodiments, the server 108 is a computing device, such as a server computer. The server 108 can include input/output devices, a central processing unit (“CPU”), a data storage device, and a network device.

In a basic configuration, the computing device 108 typically includes at least one processing unit 602 and system memory 604. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of a networked personal computer, such as the WINDOWS® operating systems from Microsoft Corporation of Redmond, Wash. or a server, such as Windows Sharepoint Server 2007, also from Microsoft Corporation of Redmond, Wash. The system memory 604 may also include one or more software applications 608 and may include program data.

The computing device 108 may have additional features or functionality. For example, the computing device 108 may also include additional data storage devices (removable and/or non-removable) such as, for example, magnetic disks, optical disks, or tape. Such additional storage is illustrated in FIG. 6 by removable storage 610 and non-removable storage 612. Computer storage media may include volatile and nonvolatile, removable and non-removable media implemented in any method or technology for storage of information, such as computer readable instructions, data structures, program modules, or other data. System memory 604, removable storage 610 and non-removable storage 612 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 108. Any such computer storage media may be part of device 108. Computing device 108 may also have input device(s) 614 such as keyboard, mouse, pen, voice input device, touch input device, etc. Output device(s) 616 such as a display, speakers, printer, etc. may also be included. These devices are well known in the art and need not be discussed at length here.

The computing device 108 may also contain communication connections 618 that allow the device to communicate with other computing devices 620, such as over a network in a distributed computing environment, for example, an intranet or the Internet. Communication connection 618 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The various embodiments described above are provided by way of illustration only and should not be construed to limiting. Various modifications and changes that may be made to the embodiments described above without departing from the true spirit and scope of the disclosure.

What is claimed is:

1. A method implemented on a server computer for creating a life cycle workflow for a project implemented on the server computer, the method comprising:
creating one or more workflow phases on the server computer, each workflow phase corresponding to a plurality of workflow stages for the project;
creating one or more workflow stages on the server computer, each of the one or more workflow stage corresponding to a specific sequence of workflow activities, each workflow stage having an identifier;
creating one or more project detail pages on the server computer, each project detail page being a web page that is made visible during a workflow stage;
when a workflow stage is created, selecting a workflow phase to be associated with the workflow stage, the workflow phase being selected from the one or more workflow phases on the server computer; and
when a workflow stage is created, selecting one or more project detail pages for the workflow stage.

2. The method of claim 1, further comprising creating an enterprise project type for the life cycle workflow for the project.

3. The method of claim 1, further comprising selecting one or more required custom fields from a plurality of workflow controlled custom fields made available on the server computer.

4. The method of claim 1, further comprising selecting one or more read only custom fields from a plurality of workflow controlled custom fields made available on the server computer.

5. The method of claim 4, further comprising the at least one read only custom field locking down the custom field for a workflow stage, the locking down of the custom field preventing the custom field from being modified during the workflow stage.

6. The method of claim 4, further comprising the behavior of the one or more read only custom fields being controlled by workflow activity for the workflow stage.

7. The method of claim 1, further comprising selecting a sequential ordering of the workflow stages associated with a workflow phase, the sequential ordering of the workflow stages requiring one workflow stage to be completed before the next workflow stage in the sequential ordering of workflow stages is activated.

8. The method of claim 1, further comprising the one or more project detail pages being rendered from a plurality of web parts.

9. The method of claim 1, further comprising selecting a sequential ordering of the project detail pages.

10. The method of claim 9, further comprising the first project detail page being a workflow status project detail page that is displayed when a workflow stage is activated.

11. The method of claim 1, further comprising selecting a strategic impact behavior for a workflow stage, the strategic impact behavior designating a business impact for a business driver associated with the workflow stage, the business impact being either a low impact, a moderate impact or a high impact.

12. The method of claim 11, further comprising designating the strategic impact behavior as read only or required.

13. The method of claim 1, further comprising designating whether the project needs to be checked in before executing one or more workflow activities in a workflow stage.

14. The method of claim 1, further comprising associating the workflow stage identifier with a specific sequence of workflow activities.

15. A method implemented on a server computer for using a life cycle workflow for a project implemented on the server computer, the method comprising:
selecting an enterprise project type for the project on the server computer, the enterprise project type being selected from a plurality of available enterprise project types, each enterprise project type associated with a workflow for a business organization, the workflow comprising one or more sequential workflow stages, each workflow stage corresponding to a specific sequence of workflow activities;
after an enterprise project type is selected, rendering a first project detail page for the first workflow stage in the one or more sequential workflow stages, the first project detail page identifying one or more additional project detail pages for the first workflow stage, at least one of the one or more additional project detail pages including one or more workflow controlled custom fields, at least one workflow controlled custom field being a required custom field; and
when all required custom fields for each of the one or more additional project detail pages for the first workflow stage are completed by a user and when project detail page information for the first workflow stage is submitted to the server computer, rendering a workflow status page for a second workflow stage on the server computer.

16. The method of claim 15, further comprising the first project detail page for a workflow stage including workflow status information.

17. The method of claim 15, further comprising at least one of the workflow controlled custom fields being a read only custom field that locks down the custom read only field for a workflow stage, the locking down of the custom read only field preventing data in the read only custom field from being modified during the workflow stage.

18. The method of claim 15, further comprising selecting a read only or required strategic impact behavior for a workflow stage, the strategic impact behavior designating a business impact for a business driver associated with the workflow stage.

19. The method of claim 15 further comprising submitting project detail information to the server computer for each of the one or more additional workflow stages, the submitting of project detail information to the server computer for a workflow stage causing a first project detail page to be rendered for the next sequential workflow stage in the workflow.

20. A computer-readable data storage medium comprising instructions that, when executed by a processing unit of an electronic computing device, cause the processing unit to:
create one or more workflow phases on the server computer, each workflow phase corresponding to a plurality of workflow stages for a project;
create one or more workflow stages on the server computer, each of the one or more workflow stages corresponding to a specific sequence of workflow activities, each workflow stage having an identifier;
creating one or more project detail pages on the server computer, each project detail page being a web page that is made visible during a workflow stage;
when a workflow stage is created, select a workflow phase to be associated with the workflow stage, the workflow phase being selected from the one or more workflow phases on the server computer;
when a workflow stage is created, select one or more project detail pages for the workflow stage;
when one or more project detail pages are selected, select an ordering for the one or more project detail pages;
select one or more required custom fields from a plurality of workflow controlled custom fields made available on the server computer;
select one or more read only custom fields from a plurality of workflow controlled custom fields made available on the server computer, at least one read only custom field corresponding to a custom field on a project detail page, the read only behavior of at least one read only custom field being controlled by workflow activity for a workflow stage;
select a strategic impact behavior for a workflow stage, the strategic impact behavior designating a business impact for a business driver associated with the workflow stage, the business impact being either a low impact, a moderate impact or a high impact, the strategic impact behavior being designated as read only or required;
designate whether the project needs to be checked in for the workflow stage; and
create an enterprise project type for the project on the server computer, the enterprise project type being associated with workflow for the project.
